(19) United States
(12) Patent Application Publication
(10) Pub. No.: US 2006/0127107 A1
(43) Pub. Date: Jun. 15, 2006

(54) Image forming apparatus and method of controlling apparatus

(75) Inventors: Yoshikatsu Kamisuwa, Tokyo (JP); Katsuya Nagamochi, Tokyo (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/008,946

(22) Filed: Dec. 13, 2004

(51) Int. Cl. G03G 15/00

(52) U.S. Cl. 399/26; 399/48

(57) ABSTRACT

Periodically, the dark attenuation characteristic of the electric potential on the surface of the photo conductor drum 20 is detected. Then, the target value −Vgt of the grid bias voltage −Vg of the charging unit 24 necessary for maintaining the charged electric potential −Vod of the developing position of the surface of the photo conductor drum 20 at the set value −Vods is detected from the above detected dark attenuation characteristic. At image formation where the developing unit 24 works, the value of the grid bias voltage −Vg of the charging unit 24 is set at the above detected target value −Vgt.

### BACKGROUND OF THE INVENTION

1. Field of the Invention

The present invention relates to an image forming apparatus having a photo conductor and a method of controlling the apparatus.

2. Description of the Related Art

In an image forming apparatus such as a photo copier, a printer and the likes, the surface of a photo conductor drum charged by an charging unit is exposed by laser beams according to an image read from an document or image data input from an external device. By the exposure, an electrostatic latent image is formed on the surface of the photo conductor drum. The formed electrostatic latent image, by being applied developing agents (toner and carrier), is developed (imaged) to becomes a visible image. The visible image is transferred onto a paper sheet.

The surface electric potential of the charged photo conductor drum will attenuate gradually. The attenuation of the surface electric potential will affect upon image formation, even if it takes for a short time while the surface of the rotating photo conductor drum goes from the charging unit to a developing unit. The attenuation of the surface electric potential becomes larger as the photo conductor drum comes closer to its service life limit.

### BRIEF SUMMARY OF THE INVENTION

Accordingly, the object of the present invention is to provide an image forming apparatus that enables to always form an appropriate image, irrespective of the attenuation of the surface electric potential of a photo conductor.

The image forming apparatus 6f this invention comprising: a rotating type photo conductor; a discharge unit configured to remove electric charge residual on the surface of the photo conductor; an charging unit configured to give electric charge to the surface of the photo conductor discharged by the discharge unit, and have a grid for adjusting charged output according to the value of impressed grid bias voltage; an exposure unit configured to expose the surface of the photo conductor charged by the charging unit; a developing unit configured to develop the surface of the photo conductor exposed by the exposure unit; an electric potential sensor configured to detect charged electric potential on the surface of the photo conductor charged by the charging unit; first control means configured to turn on the discharge unit and the charging unit and turn off the exposure unit, periodically or under predetermined conditions, and set the value of the grid bias voltage at a predetermined value, and rotate the photo conductor, thereafter stop the rotation of the photo conductor and turn off the discharge unit and the charging unit; first detecting means configured to detect dark attenuation characteristic of electric potential on the surface of the photo conductor according to detection results of the electric potential sensor, after the charging unit is turned off by the first control means; second detecting means configured to detect a target value of the grid bias voltage necessary for maintaining charged electric potential of the position corresponding to the developing unit on the surface of the photo conductor at a predetermined set value, from the dark attenuation characteristic detected by the first detecting means; and second control means configured to set the value of the grid bias voltage to the target value detected by the second detecting means, at image formation where the developing unit works.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a view showing the internal structure of a first embodiment of the present invention;

FIG. 2 is a diagram showing the details around a photo conductor drum and a control circuit in the first embodiment;

FIG. 3 is a flow chart for explaining actions of the first embodiment;

FIG. 4 is a flow chart following FIG. 3;

FIG. 5 is a graph showing the change (dark attenuation characteristic curve) of charged electric potential on the surface of a photo conductor drum in each embodiment;

FIG. 6 is a graph showing sampling results of electric potential detected by an electric potential sensor in each embodiment;

FIG. 7 is a graph showing part of the dark attenuation characteristic curve in the first embodiment;

FIG. 8 is a view showing the internal structure of a second embodiment of the invention;

FIG. 9 is a diagram showing the details around a photo conductor drum and a control circuit in the second embodiment;

FIG. 10 is a flow chart for explaining actions of the second embodiment;

FIG. 11 is a flow chart following FIG. 10; and

FIG. 12 is a graph showing the dark attenuation characteristic curve in the second embodiment.

### DETAILED DESCRIPTION OF THE INVENTION

[1] Hereinafter, a first embodiment of the present invention will be explained in more details by reference to the attached drawings.

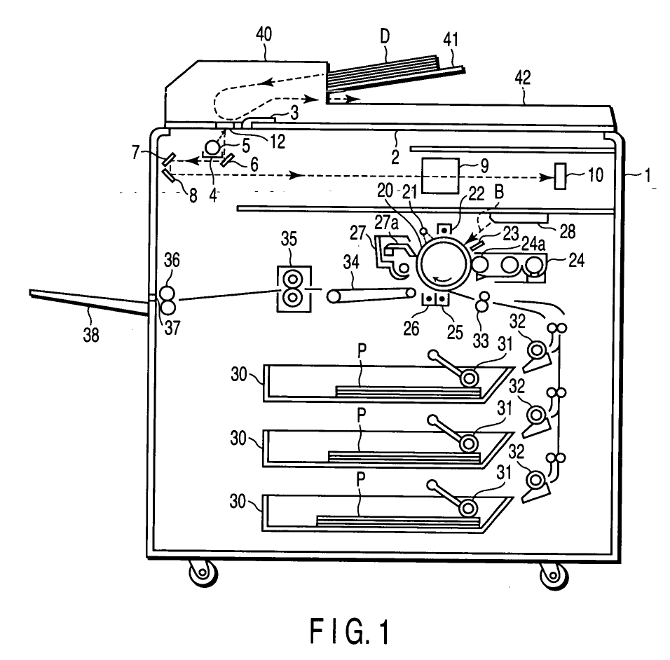

As shown in FIG. 1, a transparent document platen (glass plate) 2 for loading an document is arranged on the top of a main body 1. At one side of the document platen 2, an indicator 3 is arranged. The bump portion between the indicator 3 and the document platen 2 is the reference position for setting the document.

Under the document platen 2, a carriage 4 is arranged, and an exposure lamp 5 is arranged to the carriage 4. The carriage 4 may move (reciprocate) along the undersurface of the document platen 2. The carriage 4 reciprocates along the document platen 2, and the exposure lamp 5 lights on, and thereby, the document put on the document platen 2 is exposed.

By this exposure, a reflected light image from the document is obtained, and is projected to a charge coupled device (CCD) 10 by reflection mirrors 6, 7, 8, and a variable power lens block 9. The CCD 10 outputs image signals corresponding to the projected image.

The image signals output from the CCD 10 are converted into digital signals, and the digital signals are supplied to an exposure unit 28. The exposure unit 28 emits laser beams B corresponding to input signals.

A window 12 for reading the document is arranged in the vicinity of the indicator 3. On the document platen 2, indicator 3, and window 12, an automatic document feeder (ADF) 40 to also function as a document platen cover is arranged so as to be freely opened and closed. The automatic document feeder 40 has a tray 41 for loading the document, and feeds plural documents D one by one which is set to the tray 41 to the window 12 to cause the documents to pass through the window 12, thereby discharging the documents D that have passed through the window to a tray 42. When the automatic document feeder 40 operates, the exposure lamp 5 emits light at the position corresponding to the window 12, and the light is radiated to the window 12. The light radiated to the window 12 is radiated to the document D on the window 12. By the radiation, a reflected light image from the document D is obtained, and is projected to the CCD 10 by the reflection mirrors 6, 7, 8, and the variable power lens block 9.

On the other hand, a rotating type photo conductor, for example, a photo conductor drum 20 is arranged in the vicinity of the exposure unit 28. Around the photo conductor drum 20, a discharge unit 21, an charging unit 22, an electric potential sensor 23, a developing unit 24, a transfer unit 25, a peeling unit 26, and a cleaning unit 27 are arranged sequentially. The laser beam B emitted from the exposure unit 28 is radiated, via the charging unit 22 and the electric potential sensor 23, onto the surface of the photo conductor drum 20.

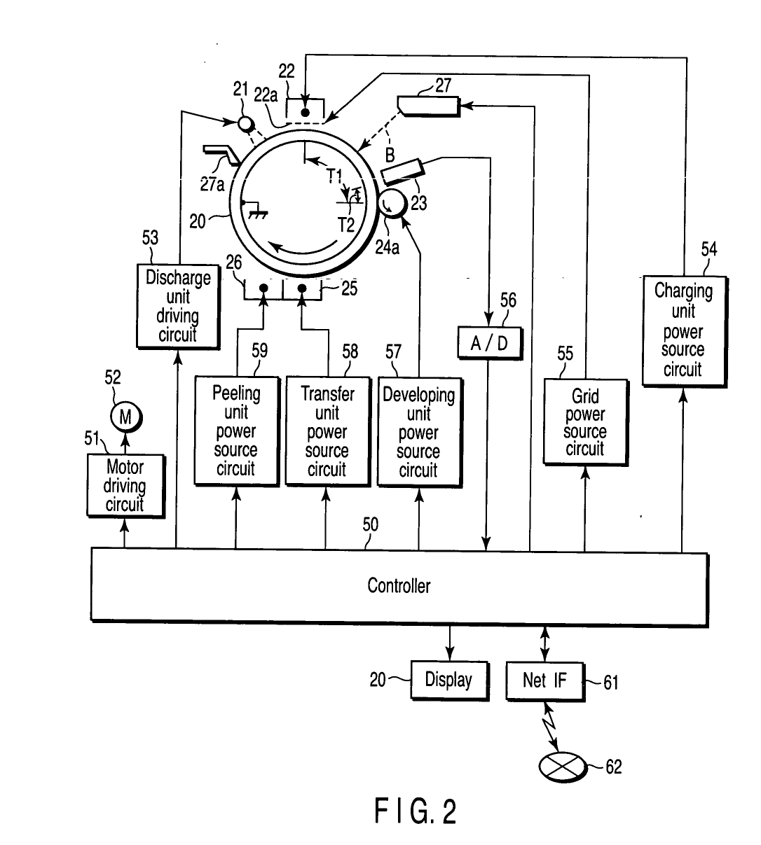

The discharge unit 21 radiates light of a lamp or a light emitting diode onto the photo conductor drum 20, and thereby removes (discharges) electric charge residual on the surface of the photo conductor drum 20. The charging unit 22 applies high voltage onto the photo conductor drum 20, and thereby applies static charge onto the surface of the photo conductor drum 20. The surface of the photo conductor drum 20 charged in this manner is exposed by the laser beam B of the exposure unit 28, whereby an electrostatic latent image is formed on the surface of the photo conductor drum 20. The charging unit 22, as shown in FIG. 2, has a grid 22a for adjusting charged output to the photo conductor drum 20.

The electric potential sensor 23 detects the electric potential of the surface of the photo conductor drum 20 in a non-contact manner. Namely, by the electric potential sensor 23, it is possible to detect the charged electric potential −Vo of the surface of the photo conductor drum 20 charged by the charging unit 22.

The developing unit 24 has a developing roller 24a that rotates in contact to the surface of the photo conductor drum 20, and thereby supplies developing agents (toner and carrier) contained in advance onto the surface of the photo conductor drum 20 by the developing roller 24a. Thereby, the electrostatic latent image on the surface of photo conductor drum 20 is developed into a visible image. The transfer unit 25 transfers the visible image on the surface of the photo conductor drum 20, to a paper sheet P supplied from a resist roller 33 to be described later herein. The peeling unit 26 peels off the paper sheet P that has passed through the transfer unit 25 from the photo conductor drum 20. The cleaning unit 27 has a blade 27a that contacts the surface of the photo conductor drum 20, and removes developing agents and the like residual on the surface of the photo conductor drum 20.

At the lower portion of the main body 1, plural paper sheet cassettes 30 are arranged. The paper sheet cassettes 30 contain many paper sheets P of respectively different sizes. Paper sheets P are taken out one by one from one of the paper sheet cassettes 30. For taking out paper sheets, a pickup roller 31 is arranged in each of the paper sheet cassettes 30. Each of the paper sheets P taken out is separated from the paper sheet cassettes 30 by a separating roller 32, and sent to a resist roller 33. The resist roller 33 feeds each of the paper sheets P into between the photo conductor drum 20 and the transfer unit 25, at timing drum 20.

The paper sheet P peeled off from the photo conductor drum 20 is sent to a fixing unit 35 by a transfer belt 34. The fixing unit 35 fixes a transfer image on the paper sheet P by heat. The fixed paper sheet P is sent to a discharge port 37 by a paper eject roller 36, and is discharged from the discharge port 37 to a tray 38 out of the main body 1.

The details around a photo conductor drum 20 and a control circuit 20 are shown in FIG. 2.

Reference numeral 50 is a controller that controls the entire main body 1. To the controller 50, a motor driving circuit 51, a discharge unit 53, an charging unit power source circuit 54, a grid power source circuit 55, an A/D (analog/digital) converting unit 56, a developing unit power source circuit 57, a transfer unit power source circuit 58, a peeling unit power source circuit 59, a display 60, and a net interface 61 are connected.

The motor driving circuit 51 drives a motor 52 in response to instructions of the controller 50. The motor 52 drives the photo conductor drum 20, and also drives the transfer mechanism of the paper sheet P and the like. The discharge unit driving circuit 53 drives the discharge unit 21 in response to instructions of the controller 50. The charging unit power source circuit 54 outputs high voltage for charging. This output is supplied to the charging unit 22. The grid power source circuit 55 outputs grid bias voltage for adjusting the charged output of the charging unit 22. The output is supplied to the grid 22a of the charging unit 22. The A/D converting unit 56 converts the detected signals of the electric potential sensor 23 into digital signals. The developing unit power source circuit 57 outputs bias voltage for developing, that is, so-called developing bias voltage to the developing unit 24. The developing bias voltage is supplied to the developing roller 24a of the developing unit 24. The transfer unit power source circuit 58 outputs high voltage for transferring. This output is supplied to the transfer unit 25. The peeling unit power source circuit 59 outputs voltage for peeling. This output is supplied to the peeling unit 26. The display 60 displays information for users and maintenance service workers. The net interface 61 sends and receives data between the controller 50 and an external device via a communication network 62.

Actions will be explained hereinafter.

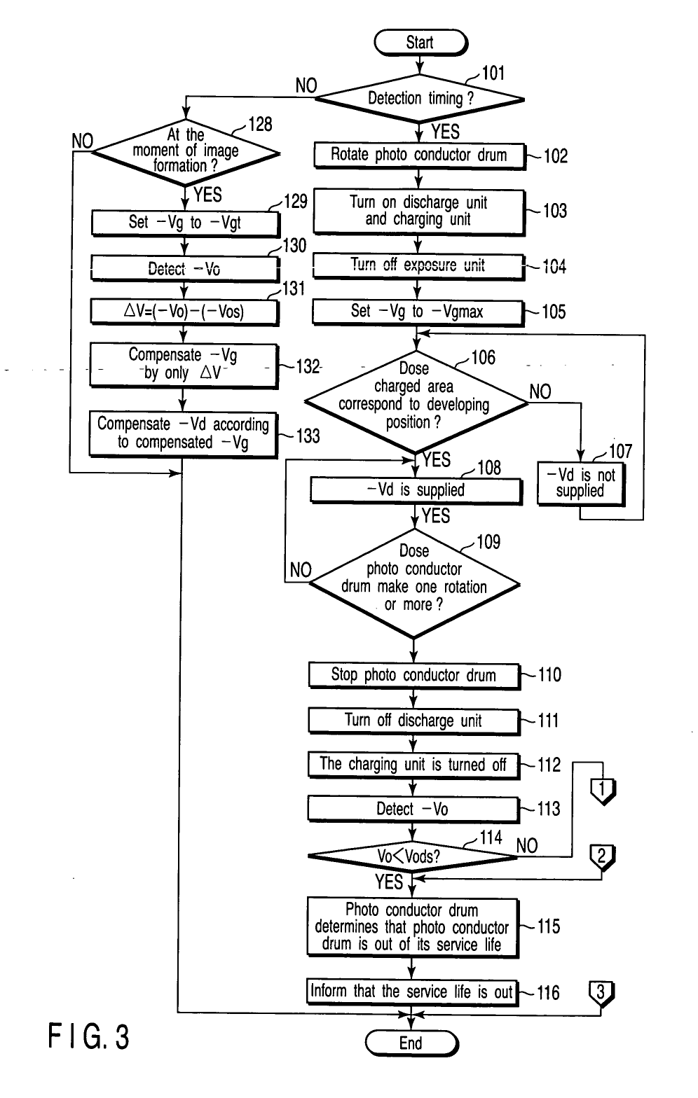

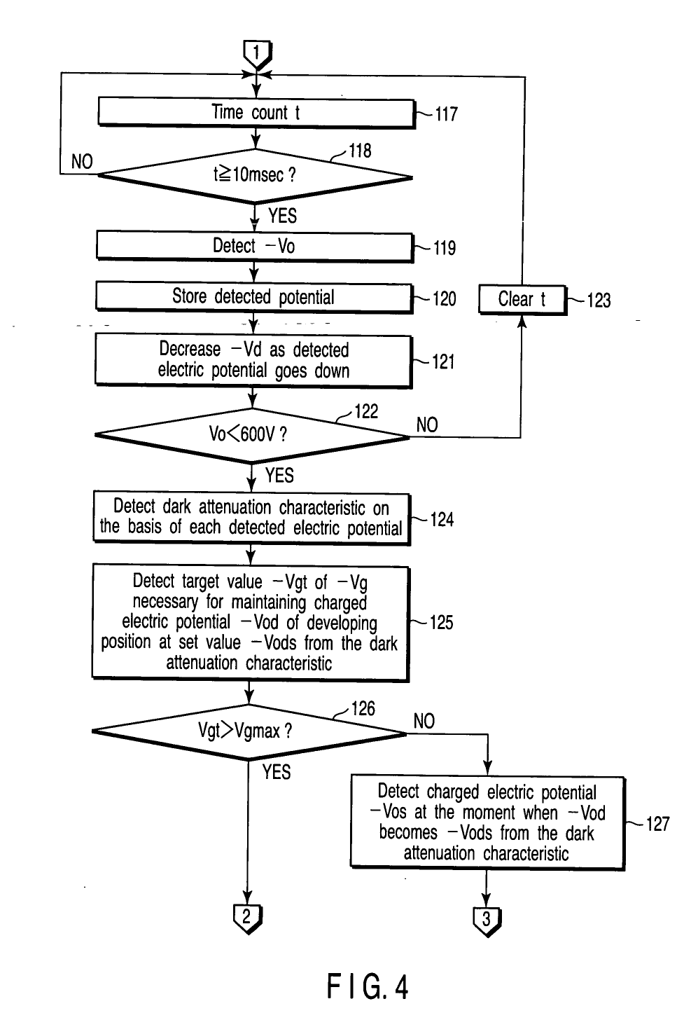

Processes of the controller 50 are shown in the flow charts in FIGS. 3 and 4.

In a periodical detection timing based on time lapse (YES in step 101), the rotation of the photo conductor drum 20 is started (step 102). Then, the discharge unit 21 and the charging unit 22 are turned on (step 103), and the exposure unit 28 is turned off (step 104). In this case, at the same time when the discharge unit 21 is turned on, electric charge residual on the surface of the photo conductor drum 20 is removed (discharged), and the discharged surface of the photo conductor drum 20 is charged by the charging unit 22. At this moment, the grid bias voltage −Vg to the grid 22a of the charging unit 22 is set to a predetermined allowable maximum value −Vgmax for example −900V (step 105). Thereby, the surface of the photo conductor drum 20 is charged first at −900V.

In this case, until the surface of the photo conductor drum 20 charged by the charging unit 22 corresponds to the developing unit 24 (NO in step 106), the developing bias voltage −Vd is not supplied to the developing roller 24a of the developing unit 24 (step 107). Because the developing bias voltage −Vd is not supplied, the developing agents (toner and carriage) in the developing unit 24 are not guided to the non-charged area of the surface of the photo conductor drum 20. Thereby, the developing agents do not attach to the non-charged area of the surface of the photo conductor drum 20. Accordingly, it is possible to prevent dirt on the photo conductor drum 20 due to the developing agents, and also to prevent unnecessary consumption of the developing agents.

When the surface of the photo conductor drum 20 charged by the charging unit 22 corresponds to the developing unit 24 (YES in step 106), the developing bias voltage −Vd is supplied to the developing roller 24a of the developing unit 24 (step 108). Because the developing bias voltage −Vd is supplied, the developing agents in the developing unit 24 are not guided to the charged area of the surface of the photo conductor drum 20. Thereby, the developing agents do not attach to the charged area of the surface of the photo conductor drum 20. Accordingly, it is possible to prevent dirt on the photo conductor drum 20 due to the developing agents, and also to prevent unnecessary consumption of the developing agents.

When the photo conductor drum 20 makes one rotation or more (YES in step 109), the photo conductor drum 20 is stopped (step 110), and the discharge unit 21 and the charging unit 22 are turned off (steps 111 and 112). At this moment, the electric potential sensor 23 detects the charged electric potential −Vo of the surface of the photo conductor drum 20 (step 113).

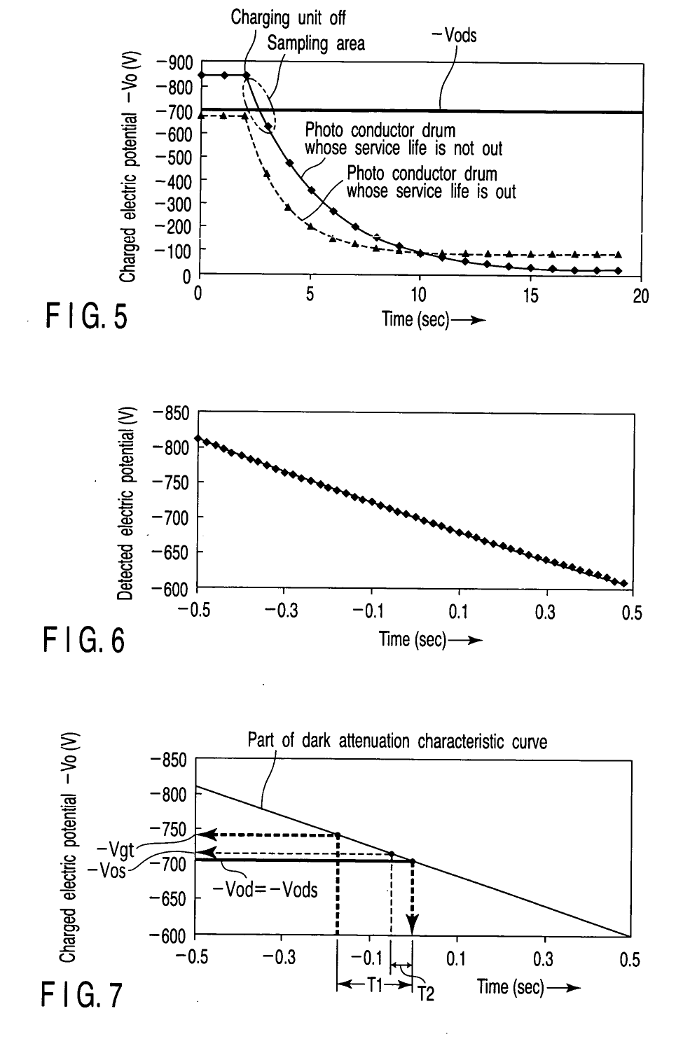

The photo conductor drum 20 has a dark attenuation characteristic where the surface electric potential will attenuate as time goes. Namely, as shown in FIG. 5, the charged electric potential −Vo of the surface of the photo conductor drum 20 attenuates as time passes, after the charging unit 22 is turned off.

Meanwhile, the charged electric potential −Vo of the surface of the photo conductor drum 20 whose service life is gone becomes lower than the charged electric potential −Vo of the surface of the photo conductor drum 20 whose service life is not out. Further, to the charged electric potential −Vo of the surface of the photo conductor drum 20, as the set value −Vods most suitable for developing of the developing unit 24, for example −700V is selected. In the photo conductor drum 20 whose service life is not out, Vo becomes Vods or higher.

After the charging unit 22 is turned off, the charged electric potential −Vo detected by the electric potential sensor 23 and the set value −Vods are compared (step 114). If Vo is below Vods (YES in step 114), it is determined that the photo conductor drum 20 is out of its service life (step 115). Then, the effect to that the service life is out is displayed by the display 60 (step 116). By this display, the service life outage of the photo conductor drum 20 is informed to users. Users request maintenance service workers to exchange the photo conductor drum 20 with a new one.

After the charging unit 22 is turned off, if Vo is Vods or higher (NO in step 114), it is determined that the photo conductor drum 20 is not out of its service life, and time count t is started (step 117). When the time count t reaches a specified time, for example, 10 msec (YES in step 118), the charged electric potential −Vo of the surface of the photo conductor drum 20 is detected by the-electric potential sensor 23 (step 119). Then, the charged electric potential −Vo detected by the electric potential sensor 23 is memorized (step 120). Further, the charged voltage −Vo detected by the electric potential sensor 23 is compared with a predetermined set value, for example, −600V (step 122).

If Vo is 600V or higher (NO in step 122), the time count t is cleared (step 123), and the time count t is started once again (step 117). Thereafter, the same process is repeated until Vo becomes below 600V. By this repetition, the detection electric potential of the electric potential sensor 23 is sampled at every 10 msec. This sampling data is shown in FIG. 6. The period from the start of the sampling to the end thereof is a short period about 1 sec where the charged electric potential −Vo fluctuates over the set value −Vods. The time required for the surface of the photo conductor drum 20 moves from the position corresponding to the charging unit 22 (charging position) to the position corresponding to the developing unit 24 (developing position) is as short as several hundred msec, and is included in the period of the above sampling.

In the above sampling period, as the detected electric potential of the electric potential sensor 23 goes down, the developing bias voltage −Vd that is impressed to the developing unit 24 is decreased (step 121). Because the developing bias voltage −Vd is decreased as the charged electric potential −Vo goes down, it is possible to prevent the developing agents in the developing unit 24 from being guided to the charged area of the surface of the photo conductor drum 20.

On the basis of the above sampled detected electric potential, the dark attenuation characteristic of the charged electric potential −Vo of the surface of the photo conductor drum 20 is detected (step 124). In concrete, by calculations by the least-square method using the sampled detected electric potential, the approximate equation of a dark attenuation characteristic curve is detected. This dark attenuation characteristic curve is shown in FIG. 7.

Then, the target value −Vgt of the grid bias voltage −Vg necessary for maintaining the charged electric potential −Vod of the developing position of the surface of the photo conductor drum 20 at the above set value −Vods (=−700V) is detected from the above detected approximate equation of the dark attenuation characteristic curve (step 125). The detected target value −Vgt is updated and recorded in an internal memory of the controller 50.

The detection process of the target value −Vgt is shown in FIG. 7. Namely, the charged electric potential −Vo at the point in time gone back by the time T1 sec required for the surface of the photo conductor drum 20 to move from the charging position to the developing position, from the point in time where the charged electric potential −Vod becomes the set value −Vods, is detected as the target value −Vgt of the grid bias voltage −Vg.

The detected target value −Vgt is compared with the above allowable maximum value −Vgmax (step 126). If Vgt is higher than Vgmax (YES in step 126), it is determined that the photo conductor drum 20 is out of its service life (step 115). Then, the effect to that the service life is out is displayed by the display 60 (step 116). By this display, the service life outage of the photo conductor drum 20 is informed to users. Users request maintenance service workers to exchange the photo conductor drum 20 with a new one.

If the target value −Vgt is allowable maximum value −Vgmax or below (NO in step 126), the charged electric potential −Vos of the position corresponding to the electric potential sensor 23 at the moment when the charged electric potential −Vod of the developing position on the surface of the photo conductor drum 20 becomes the above set value −Vods is detected from the above detected approximate equation of the dark attenuation characteristic curve (step 127). The detected charged electric potential −Vos is updated and recorded in the internal memory of the controller 50.

The detection process of the charged electric potential −Vos is shown in FIG. 7. Namely, the charged electric potential −Vo at the point in time gone back by the time T2 sec required for the surface of the photo conductor drum 20 to move from the position corresponding to the electric potential sensor 23 to the developing position, from the point in time where the charged electric potential −Vod becomes the set value −Vods, is selected as the charged electric potential −Vos of the position corresponding to the electric potential sensor 23.

On the other hand, at the moment of image formation where the developing unit 24 works (NO in step 101, YES in step 128), the value of the grid bias voltage −Vg impressed to the grid 22a of the charging unit 22 is set to the target value −Vgt memorized in the controller 50 (step 129). The target value −Vgt is a preset value in consideration of the attenuation of the charged electric potential −Vo. Therefore, the charged electric potential −Vod of the developing position on the surface of the photo conductor drum 20 is maintained at the set value −Vods that is best fit for developing. Accordingly, it is possible to always form an appropriate image, without influence by the dark attenuation characteristic of the surface electric potential of the photo conductor drum 20.

Along the tendency toward the compact size of the main body 1, it has become difficult to attach the electric potential sensor 23 close to the developing unit 24. Even under such a circumstances, it is possible to maintain the charged electric potential −Vod of the developing position on the surface of the photo conductor drum 20 at the set value −Vods that is best fit for developing.

The dark attenuation characteristic will not fluctuate abruptly, however, due to changes of environments such as temperature and humidity and the likes, or the number of images to be formed and so forth, the charged electric potential −Vo might fluctuate inevitably.

Therefore, the charged electric potential −Vo is detected by the electric potential sensor 23 (step 130), and the difference ΔVg between the detected electric potential of the electric potential sensor 23 and the charged electric potential −Vos memorized in the controller 50 (charged electric potential of the position corresponding to the electric potential sensor 23) is obtained (step 131). Then, the value of the grid bias voltage −Vg that has been once set to the target value −Vgt as described above is compensated by the above obtained difference ΔVg (step 133). By this compensation, the charged electric potential −Vod of the developing position on the surface of the photo conductor drum 20 is maintained at the set value −Vods that is best fit for developing, without influences by changes of environments such as temperature and humidity and the likes, or the number of images to be formed and so forth. Accordingly, it is possible to always form an appropriate image.

[2] A second embodiment of the present invention will be explained hereinafter.

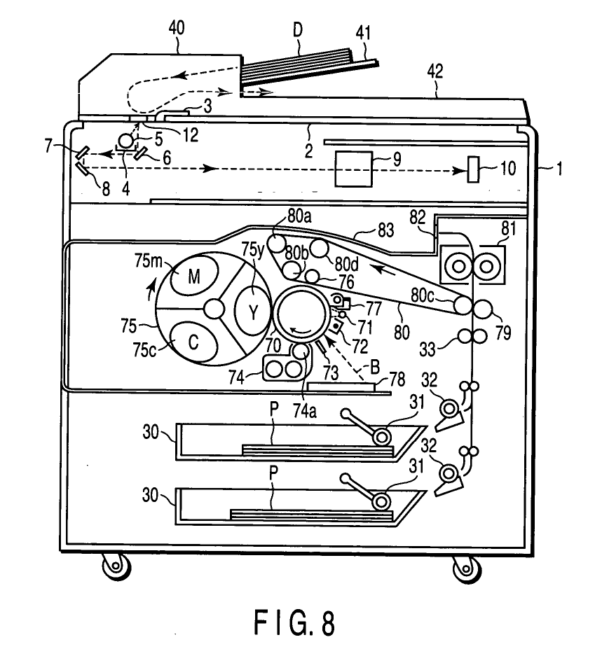

As shown in FIG. 8, image signals output from the CCD 10 are converted into digital signals and supplied to an exposure unit 78. The exposure unit 77 emits laser beams B corresponding to input signals.

A rotating type photo conductor drum 70 is arranged in the vicinity of the exposure unit 78. Around this photo conductor drum 70, a discharge unit 71, an charging unit 72, an electric potential sensor 73, a black developing unit 74, a color developing unit 75, a transfer roller 76, and a cleaning unit 77 are arranged sequentially. The laser beam B emitted from the exposure unit 78 is radiated, via the charging unit 72 and the electric potential sensor 73, onto the surface of the photo conductor drum 70.

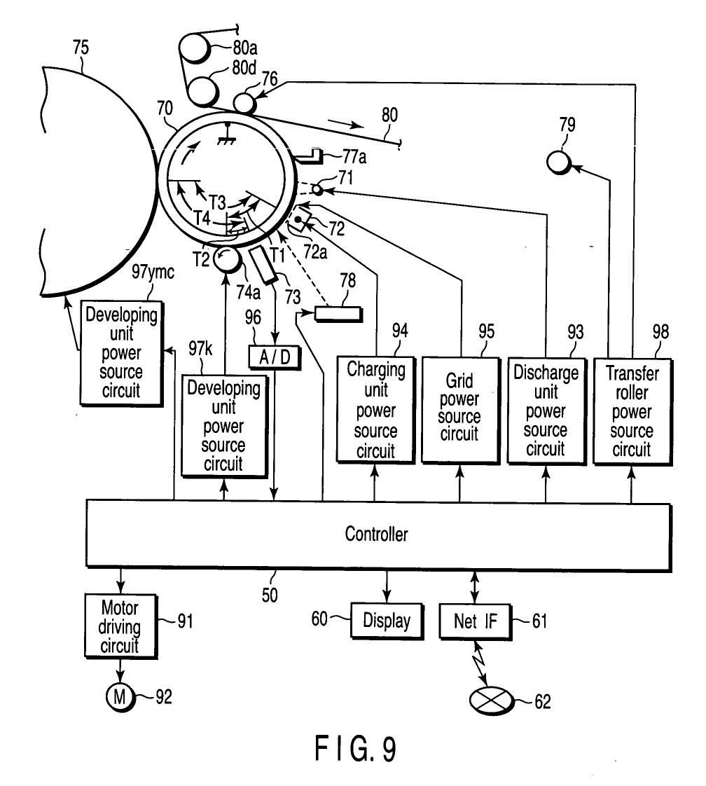

The discharge unit 71 radiates light of a lamp or a light emitting diode onto the photo conductor drum 70, thereby removes (discharges) electric charge residual on the surface of the photo conductor drum 70. The charging unit 72 gives high voltage onto the photo conductor drum 70, thereby gives static charge onto the surface of the photo conductor drum 70. The surface of the photo conductor drum 70 charged in this manner is exposed by the laser beam B of the exposure unit 78, thereby, an electrostatic latent image is formed on the surface of the photo conductor drum 70. The charging unit 72, as shown in FIG. 9, has a grid 72a for adjusting charged output to the photo conductor drum 70.

The electric potential sensor 73 detects the electric potential of the surface of the photo conductor drum 70 in non contact manners. Namely, by the electric potential sensor 73, it is possible to detect the charged electric potential −Vo of the surface of the photo conductor drum 70 charged by the charging unit 72.

The black developing unit 74 contacts the surface of the photo conductor drum 70 at formation of black images, and goes away from the photo conductor drum 70 at formation of yellow, magenta, and cyan images. Further, the black developing unit 74 has a developing roller 74a that rotates in connection with the rotation of the photo conductor drum 70 when it contacts the surface of the photo conductor drum 70, and thereby contained in advance onto the surface of photo conductor drum 70 by the developing roller 74a. Thereby, the electrostatic latent-image on the surface of photo conductor drum 70 is developed into a black visible image.

The color developing unit 75 contacts the surface of the photo conductor drum 70 at formation of any of yellow, magenta, and cyan images, and goes away from the photo conductor drum 70 at formation of black images. Further, the color developing unit 75 has a yellow developing section 75y, a magenta developing section 75m, and a cyan developing section 75c, and makes the yellow developing section 75y contact the surface of the photo conductor drum 70 at formation of yellow images, and makes the magenta developing section 75m contact the surface of the photo conductor drum 70 at formation of magenta images, and makes the cyan developing section 75c contact the surface of-the photo conductor drum 70 at formation of cyan images. The yellow developing section 75y, when contacting the surface of the photo conductor drum 70, supplies developing agents (yellow toner and carrier) contained in advance onto the surface of photo conductor drum 70. Thereby, the electrostatic latent image on the surface of photo conductor drum 70 is developed into a yellow visible image. The magenta developing section 75m, when contacting the surface of the photo conductor drum 70, supplies developing agents (magenta toner and carrier) contained in advance onto the surface of photo conductor drum 70. Thereby, the electrostatic latent image on the surface of photo conductor drum 70 is developed into a magenta visible image. The cyan developing section 75c, when contacting the surface of the photo conductor drum 70, supplies developing agents (cyan toner and carrier) contained in advance onto the surface of photo conductor drum 70. Thereby, the electrostatic latent image on the surface of photo conductor drum 70 is developed into a cyan visible image.

A rotating type transfer belt 80 is pinched between a transfer roller 76 and the photo conductor drum 70. The transfer roller 76 transfers the visible image on the surface of the photo conductor drum 70 to a transfer belt 80. The transfer belt 80 is arranged onto rollers 80a, 80b, 80c, and 80d, and rotates between the photo conductor drum 70 and a transfer roller 79 to be described later herein. The cleaning unit 77, as shown in FIG. 9, has a blade 77a that contacts the surface of the photo conductor drum 70, and thereby removes the developing agents and the likes residual on the surface of the photo conductor drum 70.

At the lower portion of the main body 1, plural paper sheet cassettes 30 are arranged. Paper sheets P are taken out one by one from one of the paper sheet cassettes 30. For taking out paper sheets, a pickup roller 31 is arranged in each of the paper sheet cassettes 30. Each of the paper sheets P taken out is separated from the paper sheet cassettes 30 by a separating roller 32, and sent to a resist roller 33. The resist roller 33 feeds each of the paper sheets P into between the transfer belt 80 and the transfer roller 79, at timing in consideration of the rotation of the transfer belt 80. The transfer roller 79 transfers the visible image on the surface of the transfer belt 80 to the paper sheet P supplied from the resist roller 33.

The paper sheet P on which the visible image of the transfer belt 80 has been transferred is sent to a fixing unit 81. The fixing unit 81 fixes a transfer image on the paper sheet P by heat. The fixed paper sheet P is discharged from a discharge port 82 to a tray 83 on the main body 1.

The details around a photo conductor drum 70 and a control circuit are shown in FIG. 9.

Reference numeral 50 is a controller that controls the entire main body 1. To this controller 50, a motor driving circuit 91, a discharge unit 93, an charging unit power source circuit 94, a grid power source circuit 95, an A/D (analog/digital) converting unit 96, a developing unit power source circuits 97k, 97ymc, a transfer roller power source circuit 98, a display 60, and a net interface 61 are connected.

The motor driving circuit 91 drives a motor 92 in response to instructions of the controller 50. The motor 92 drives the photo conductor drum 70, the color developing unit 75, the transfer belt 80, and the transfer mechanism of the paper sheet P and so forth. The discharge unit driving circuit 93 drives the discharge unit 91 in response to instructions of the controller 50. The charging unit power source circuit 94 outputs high voltage for charging. This output is supplied to the charging unit 92. The grid power source circuit 95 outputs grid bias voltage for adjusting the charged output of the charging unit 92. This output is supplied to the grid 92a of the charging unit 92. The A/D (analog/digital) converting unit 96 converts the detected signals of the electric potential sensor 73 into digital signals. A developing unit power source circuit 97k outputs bias voltage for developing to the black developing unit 74. The developing unit power source circuit 97ymc outputs bias voltage for developing to the yellow developing section 75y, the magenta developing section 75m, and the cyan developing section 75c of the color developing unit 75. The transfer roller power source circuit 98 outputs high voltage for transferring. This output is supplied to the transfer rollers 76 and 79. The display 60 displays information for users and maintenance service workers. The net interface 61 sends and receives data between the controller 50 and external devices via a communication network 62.

Actions are explained hereinafter.

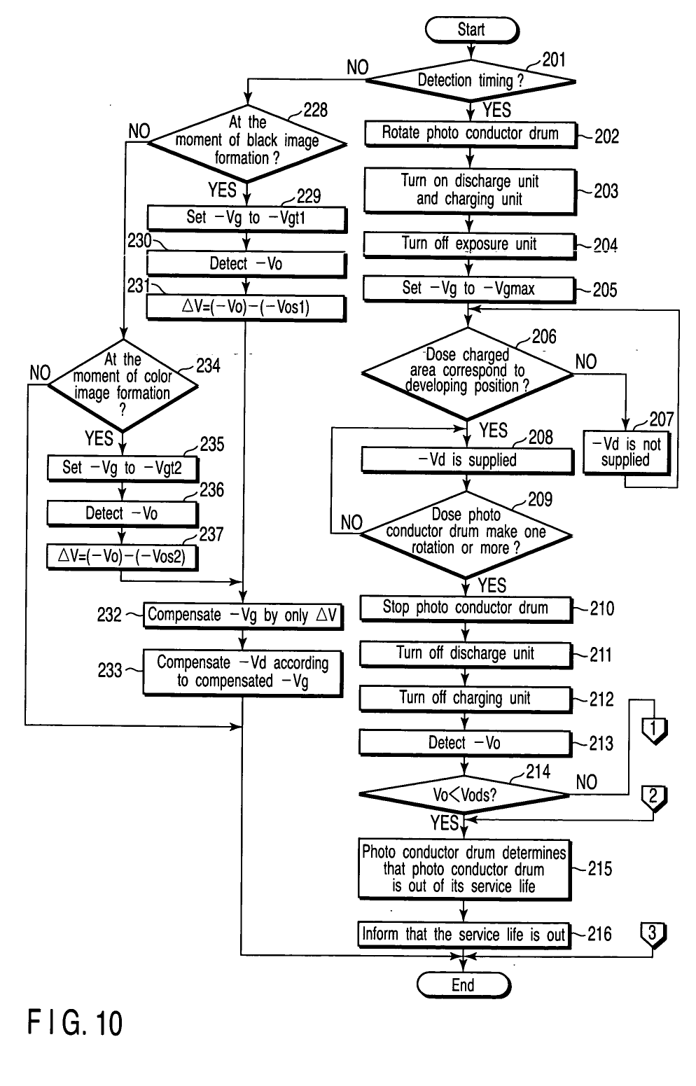

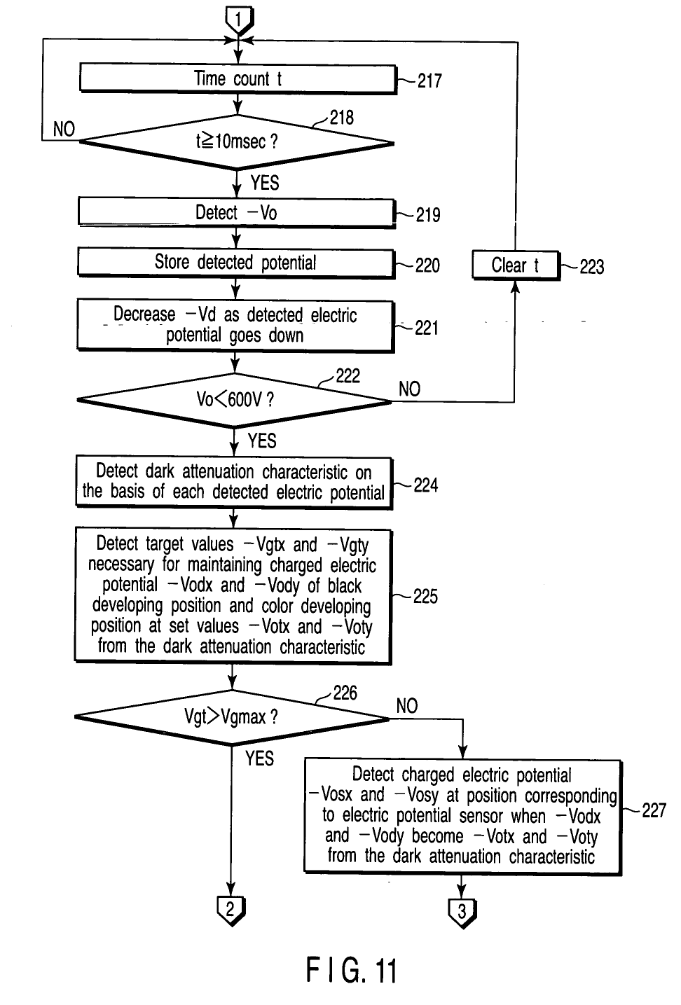

Processes of the controller 50 are shown in the flow charts in FIGS. 10 and 11.

In a periodical detection timing based on time lapse (YES in step 201), the rotation of the photo conductor drum 70 is started (step 202). Then, the discharge unit 71 and the charging unit 72 are turned on (step 203), and the exposure unit 78 is turned off (step 204). In this case, at the same time when the discharge unit 71 is turned on, electric charge residual on the surface of the photo conductor drum 70 is removed (discharged), and the discharged surface of the photo conductor drum 70 is charged by the charging unit 72. At this moment, the grid bias voltage −Vg to the grid 72a of the charging unit 72 is set to a predetermined allowable maximum value −Vgmax for example −900V (step 205). Thereby, the surface of the photo conductor drum 70 is charged first at −900V.

In this case, until the surface of the photo conductor drum 70 charged by the charging unit 72 corresponds to the black developing unit 74 (NO in step 206), the developing bias voltage −Vd is not supplied to the developing unit 74 (step 207). Until the surface of the photo conductor drum 70 charged by the charging unit 72 corresponds to the color developing unit 75 (NO in step 206), the developing bias voltage −Vd is not supplied to the color developing unit 75 (step 207). Because the developing bias voltage −Vd is not supplied, the developing agents (toner and carriage) in the black developing unit 74 and the color developing unit 75 are not guided to the non-charged area of the surface of the photo conductor drum 70. Thereby, the developing agents do not attach to the non-charged area of the surface of the photo conductor drum 70. Accordingly, it is possible to prevent dirt on the photo conductor drum 70 due to the developing agents, and also to prevent unnecessary consumption of the developing agents.

When the surface of the photo conductor drum 70 charged by the charging unit 72 corresponds to the black developing unit 74 (YES in step 206), the developing bias voltage −Vd is supplied to the black developing unit 24 (step 208). When the surface of the photo conductor drum 70 charged by the charging unit 72 corresponds to the color developing unit 75 (YES in step 206), the developing bias voltage −Vd is supplied to the color developing unit 75 (step 208). Because the developing bias voltage −Vd is supplied, the developing agents in the black developing unit 74 and the color developing unit 75 are not guided to the charged area of the surface of the photo conductor 70. Thereby, the developing agents do not attach to the charged area of the surface of the photo conductor drum 70. Accordingly, it is possible to prevent dirt on the photo conductor drum 70 due to the developing agents, and also to prevent unnecessary consumption of the developing agents.

When the photo conductor drum 70 makes one rotation or more (YES in step 209), the photo conductor drum 70 is stopped (step 210), and the discharge unit 71 and the charging unit 72 are turned off (steps 211 and 212). At this moment, by the electric potential sensor 73, the charged electric potential −Vo of the surface of the photo conductor drum 70 is detected (step 213).

The photo conductor drum 70 has a dark attenuation characteristic where the surface electric potential will attenuate as time goes. Namely, as shown in FIG. 5, the charged electric potential −Vo of the surface of the photo conductor drum 70 attenuates as time passes, after the charging unit 22 is turned off.

Meanwhile, the charged electric potential −Vo of the surface of the photo conductor drum 70 whose service life is gone becomes lower than the charged electric potential −Vo of the surface of the photo conductor drum 70 whose service life is not out. Further, to the charged electric potential −Vo of the surface of tile photo conductor drum 70, as the set value −Vods most suitable for developing of the black developing unit 74 and the color developing unit 75, for example −700V is selected. The charged electric potential −Vo of the photo conductor drum 70 whose service life is not out becomes Vods or higher.

After the charging unit 72 is turned off, the charged electric potential −Vo detected by the electric potential sensor 73 and the set value −Vods are compared (step 214). If Vo is below Vods (YES in step 214), it is determined that the photo conductor drum 70 is out of its service life (step 215). Then, the effect to that the service life is out is displayed by the display 60 (step 216). By this display, the service life outage of the photo conductor drum 70 is informed to users. Users request maintenance service workers to exchange the photo conductor drum 70 with a new one.

After the charging unit 72 is turned off, if Vo is Vods or higher (NO in step 214), it is determined that the photo conductor drum 70 is not out of its service life, and time count t is started (step 217). When the time count t reaches a specified time, for example, 10 msec (YES in step 218), the charged electric potential −Vo of the surface of photo conductor drum 70 is detected by the electric potential sensor 73 (step 219). Then, the charged electric potential −Vo detected by the electric potential sensor 73 is memorized (step 220). Further, the charged voltage −Vo detected by the electric potential sensor 73 is compared with a predetermined set value, for example, −600V (step 222).

If Vo is 600V or higher (NO in step 222), the time count t is cleared (step 223), and the time count t is started once again (step 217). Thereafter, the same process is repeated until Vo becomes below 600V. By this repetition, the detected electric potential of the electric potential sensor 23 is sampled at every 10 msec. This sampling data is shown in FIG. 6. The period from the start of the sampling to the end thereof is a short period about 1 sec where the charged electric potential −Vo fluctuates over the set value −Vods. The time required for the surface of the photo conductor drum 70 moves from the position corresponding to the charging unit 72 (charging position) to the position corresponding to the black developing unit 74 and the color developing unit 75 (developing position) is as short as several hundred msec, and is included in the period of the above sampling.

In the above sampling period, as the detected electric potential of the electric potential sensor 73 goes down, the developing bias voltage −Vd that is impressed to the black developing unit 74 and the color developing unit 75 is decreased respectively (step 221). Because the developing bias voltage −Vd is decreased as the charged electric potential −Vo goes down, it is possible to prevent the developing agents in the black developing unit 74 and the color developing unit 75 from being guided to the charged area of the surface of the photo conductor drum 70.

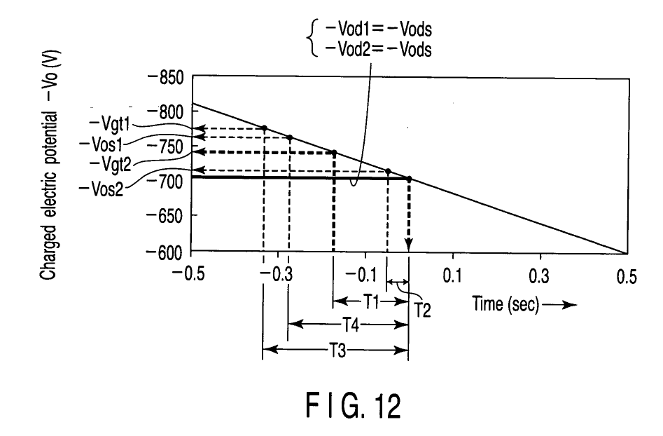

On the basis of the above sampled detected electric potential, the dark attenuation characteristic of the charged electric potential −Vo of the surface of photo conductor drum 70 is detected (step 224). In concrete, by calculations by the least-square method using the sampled detected electric potential, the approximate equation of a dark attenuation characteristic curve is detected. This dark attenuation characteristic curve is shown in FIG. 12.

Then, the target value −Vgt1 of the grid bias voltage −Vg necessary for maintaining the charged electric potential −Vod1 of the black developing position of the surface of the photo conductor drum 70 at the above set value −Vods (=−700V) is detected from the above detected approximate equation of the dark attenuation characteristic curve (step 225). Further, the target value −Vgt2 of the grid bias voltage −Vg necessary for maintaining the charged electric potential −Vod2 of the color developing position of the surface of the photo conductor drum 70 at the above set value −Vods (=−700V) is detected from the above detected approximate equation of the dark attenuation characteristic curve (step 225). The detected target values −Vgt1 and −Vgt2 are updated and recorded in an internal memory of the controller 50.

The detection process of the target values −Vgt1 and −Vgt2 is shown in FIG. 12. Namely, the charged electric potential −Vo at the point in time gone back by the time T1 sec required for the surface of the photo conductor drum 70 to move from the charging position to the black developing position, from the point in time where the charged electric potential −Vod1 of the black developing position by the black developing unit 74 becomes the set value −Vods, is selected as the target value −Vgt1 of the grid bias voltage −Vg at formation of black images. The charged electric potential −Vo at the point in time gone back by the time T3 sec required for the surface of the photo conductor drum 70 to move from the charging position to the color developing position, from the point in time where the charged electric potential −Vod2 of the color developing position by the color developing unit 75 becomes the set value −Vods, is selected as the target value −Vgt2 of the grid bias voltage −Vg at formation of color images.

The detected target values −Vgt1 and −Vgt2 are compared with the above allowable maximum value −Vgmax (step 226). If either Vgt1 or Vgt2 is higher than Vgmax (YES in step 226), it is determined that the photo conductor drum 70 is out of its service life (step 215). Then, the effect to that the service life is out is displayed by the display 60 (step 216). By this display, the service life outage of the photo conductor drum 70 is informed to users. Users request maintenance service workers to exchange the photo conductor drum 70 with a new one.

If both the target values Vgt1 and Vgt2 are −Vgmax or below (NO in step 226), the charged electric potential −Vos1 of the position corresponding to the electric potential sensor 73 at the moment when the charged electric potential −Vod1 of the black developing position on the surface of the photo conductor drum 70 becomes the above set value −Vods is detected from the above detected approximate equation of the dark attenuation characteristic curve (step 227). At the same time, the charged electric potential −Vos2 of the position corresponding to the electric potential sensor 73 at the moment when the charged electric potential −Vod2 of the color developing position on the surface of the photo conductor drum 70 becomes the above set value −Vods is detected from the above detected approximate equation of the dark attenuation characteristic curve (step 227). The detected charged electric potentials −Vos1 and −Vos2 are updated and recorded in the internal memory of the controller 50.

The detection process of the charged electric potentials −Vos1 and −Vos2 is shown in FIG. 12. Namely, the charged electric potential −Vod at the point in time gone back by the time T2 sec required for the surface of the photo conductor drum 70 to move from the position corresponding to the electric potential sensor 73 to the black developing position, from the point in time where the charged electric potential −Vod1 becomes the set value −Vods, is selected as the charged electric potential −Vos1 of the position corresponding to the electric potential sensor 73 at formation of black images. The charged electric potential −Vod at the point in time gone back by the time T4 sec required for the surface of the photo conductor drum 70 to move from the position corresponding to the electric potential sensor 73 to the color developing position, from the point in time where the charged electric potential −Vod2 becomes the set value −Vods, is selected as the charged electric potential −Vos2 of the position corresponding to the electric potential sensor 73 at formation of color images.

On the other hand, at the moment of black image formation where the black developing unit 74 works (NO in step 201, YES in step 228), the value of the grid bias voltage −Vg impressed to the grid 72a of the charging unit 72 is set to the target value −Vgt1 memorized in the controller 50 (step 229). The target value −Vgt1 is a preset value in consideration of the attenuation of the charged electric potential −Vo. Therefore, the charged electric potential −Vod1 of the black developing position on the surface of the photo conductor drum 70 is maintained at the set value −Vods that is best fit for black developing. Accordingly, it is possible to always form an appropriate black image, without influence by the dark attenuation characteristic of the surface electric potential of the photo conductor drum 70.

Along the tendency toward the compact size of the main body 1, it has become difficult to attach the electric potential sensor 73 close to the developing unit 74. Even under such a circumstances, it is possible to maintain the charged electric potential −Vod of the black developing position on the surface of the photo conductor drum 70 at the set value −Vods that is best fit for black developing.

Meanwhile, the dark attenuation characteristic will not fluctuate abruptly, however, due to changes of environments such as temperature and humidity and the likes, or the number of images to be formed and so forth, the charged electric potential −Vo might fluctuate inevitably.

Therefore, the charged electric potential −Vo is detected by the electric potential sensor 73 (step 230), and the difference ΔVg between the detected electric potential of the electric potential sensor 73 and the charged electric potential −Vos1 memorized in the controller 50 (charged electric potential of the position corresponding to the electric potential sensor 73) is obtained (step 231). Then, the value of the grid bias voltage −Vg that has been once set to the target value −Vgt1 as described above is compensated by the above obtained difference ΔVg (step 233). By this compensation, the charged electric potential −Vod1 of the black developing position on the surface of the photo conductor drum 20 is maintained at the set value −Vods that is best fit for black developing, without influences by changes of environments such as temperature and humidity and the likes, or the number of images to be formed and so forth. Accordingly, it is possible to always form an appropriate black image.

At the moment of color image formation where the color developing unit 75 works (NO in step 201, NO in step 228, YES in step 234), the value of the grid bias voltage −Vg impressed to the grid 72a of the charging unit 72 is set to the target value −Vgt2 memorized in the controller 50 (step 235). The target value −Vgt2 is a preset value in consideration of the attenuation of the charged electric potential −Vo. Therefore, the charged electric potential −Vod2 of the color developing position on the surface of the photo conductor drum 70 is maintained at the set value −Vods that is best fit for color developing. Accordingly, it is possible to always form an appropriate color image, without influence by the dark attenuation characteristic of the surface electric potential of the photo conductor drum 70.

Even when the position of the electric potential sensor 73 is away from the position of the color developing unit 75, it is possible to maintain the charged electric potential −Vod of the color developing position on the surface of the photo conductor drum 70 at the set value −Vods that is best fit for color developing.

The dark attenuation characteristic will not fluctuate abruptly, however, due to changes of environments such as temperature and humidity and the likes, or the number of images to be formed and so forth, the charged electric potential −Vo might fluctuate inevitably.

Therefore, the charged electric potential −Vo is detected by the electric potential sensor 73 (step 236), and the difference ΔVg between the detected electric potential of the electric potential sensor 73 and the charged electric potential −Vos2 memorized in the controller 50 (charged electric potential of the position corresponding to the electric potential sensor 73) is obtained (step 237). Then, the value of the grid bias voltage −Vg that has been once set to the target value −Vgt2 as described above is compensated by the above obtained difference ΔVg (step 237). By this compensation, the charged electric potential −Vod2 of the color developing position on the surface of the photo conductor drum 20 is maintained at the set value −Vods that is best fit for color developing, without influences by changes of environments such as temperature and humidity and the likes, or the number of images to be formed and so forth. Accordingly, it is possible to always form an appropriate color image.

[3] In the respective embodiments, in the periodical detection timing based on time lapse, the service life determination and various detections are carried out, however, the service life determination and various detections may be carried out under predetermined conditions such as when the main body is turned on, or when the number of images to be formed reaches a preset certain number, and so forth.

Further, in the above respective embodiments, the case where a photo conductor drum is employed as a photo conductor has been explained, however, the invention is not limited to this, but may be applied also to a case where a belt shape photo conductor is employed.

Additional advantages and modifications will readily occur to those skilled in the art. Therefore, the invention in its broader aspects is not limited to the specific details-and representative embodiments shown and described herein. Accordingly, various modifications may be made without departing from the spirit or scope of the general inventive concept as defined by the appended claims and their equivalents.

What is claimed is:

1. An image forming apparatus comprising:
a rotating type photo conductor;
a discharge unit configured to remove electric charge residual on the surface of the photo conductor;
an charging unit configured to give electric charge to the surface of the photo conductor discharged by the discharge unit, and have a grid for adjusting charged output according to the value of impressed grid bias voltage;
an exposure unit configured to expose the surface of the photo conductor charged by the charging unit;
a developing unit configured to develop the surface of the photo conductor exposed by the exposure unit;
an electric potential sensor configured to detect charged electric potential on the surface of the photo conductor charged by the charging unit;
first control means configured to turn on the discharge unit and the charging unit and turn off the exposure unit, periodically or under predetermined conditions, and set the value of the grid bias voltage at a predetermined value, and rotate the photo conductor, thereafter stop the rotation of the photo conductor and turn off the discharge unit and the charging unit;
first detecting means configured to detect dark attenuation characteristic of electric potential on the surface of the photo conductor according to detection results of the electric potential sensor, after the charging unit is turned off by the first control means;
second detecting means configured to detect a target value of the grid bias voltage necessary for maintaining charged electric potential of the position corresponding to the developing unit on the surface of the photo conductor at a predetermined set value, from the dark attenuation characteristic detected by the first detecting means; and
second control means configured to set the value of the grid bias voltage to the target value detected by the second detecting means, at image formation where the developing unit works.

2. An apparatus of claim 1, wherein
the predetermined value is the allowable maximum value to the value of the grid bias voltage.

3. An apparatus of claim 1, further comprising:
determining means configured to determine that the photo conductor is out of its service life, when the detected electric potential of the electric potential sensor is below the predetermined value, after the charging unit is turned off by the first control means; and
informing means configured to inform of the determination result of the determining means.

4. An apparatus of claim 2, further comprising:
first determining means configured to determine that the photo conductor is out of its service life, when the detected electric potential of the electric potential sensor is below the predetermined value, after the charging unit is turned off by the first control means;
second determining means configured to determine that the photo conductor is out of its service life, when the target value detected by the second detecting means exceeds the allowable maximum value; and
informing means configured to inform of the determination results of the first and second determining means.

5. An apparatus of claim 1, wherein
the first detecting means samples the detected electric potential of the electric potential sensor at a specified time, after the charging unit is turned off by the first control means, and detects the dark attenuation characteristic of electric potential on the surface of the photo conductor according to the sampling result.

6. An apparatus of claim 1, further comprising:
third detecting means configured to detect the charged electric potential at the position corresponding to the electric potential sensor on the surface of the photo conductor, at the moment when the charged electric potential at the position corresponding to the developing unit on the surface of the photo conductor is maintained at the set value, from the dark attenuation characteristic detected by the first detecting means; and
third control means configured to obtain the difference between the detected electric potential of the electric potential sensor and the charged electric potential detected by the third detecting means at the image formation, and compensates the value of the grid bias voltage set by the second control means by only the obtained difference.

7. An apparatus of claim 6, further comprising
fourth control means configured to adjust the value of developing bias voltage that is impressed to the developing unit, at the image formation, according to the value of the grid bias voltage compensated by the third control means.

8. An apparatus of claim 1, further comprising
fifth control means structured so as not to give developing bias voltage to the developing unit until the surface of the photo conductor charged by the charging unit corresponds to the developing unit after the process by the first control means is started, and to give the developing bias voltage to the developing unit when the surface of the photo conductor charged by the charging unit corresponds to the developing unit, and decrease the value of the developing bias voltage as the detection electrical potential of the electric potential sensor goes down.

9. An image forming apparatus comprising:
a rotating type photo conductor;
a discharge unit configured to remove electric charge residual on the surface of the photo conductor;
an charging unit configured to give electric charge to the surface of the photo conductor discharged by the discharge unit, and have a grid for adjusting charged output according to the value of impressed grid bias voltage;
an exposure unit configured to expose the surface of the photo conductor charged by the charging unit;
plural developing units configured to develop the surface of the photo conductor exposed by the exposure unit;
an electric potential sensor configured to detect charged electric potential on the surface of the photo conductor charged by the charging unit;
first control means configured to turn on the discharge unit and the charging unit and turn off the exposure unit periodically or under predetermined conditions, and set the value of the grid bias voltage at a predetermined value, and rotate the photo conductor, thereafter stop the rotation of the photo conductor and turn off the discharge unit and the charging unit;
first detecting means configured to detect dark attenuation characteristic of electric potential on the surface of the photo conductor according to detection results of the electric potential sensor, after the charging unit is turned off by the first control means;
second detecting means configured to detect respective target values of the grid bias voltage necessary for maintaining charged electric potential of the positions corresponding to the plural developing units on the surface of the photo conductor at a predetermined second set value, from the dark attenuation characteristic detected by the first detecting means; and
second control means configured to set the values of the grid bias voltage to the respective target values detected by the third detecting means, at image formation where the plural developing units work.

10. An apparatus of claim 9, wherein
the predetermined value is the allowable maximum value to the value of the grid bias voltage.

11. An apparatus of claim 9, further comprising:
determining means configured to determine that the photo conductor is out of its service life, when the detected electric potential of the electric potential sensor is below the predetermined value, after the charging unit is turned off by the first control means; and
informing means configured to inform of the determination result of the determining means.

12. An apparatus of claim 10, further comprising:
first determining means configured to determine that the photo conductor is out of its service life, when the detected electric potential of the electric potential sensor is below the predetermined value, after the charging unit is turned off by the first control means;
second determining means configured to determine that the photo conductor is out of its service life, when the target value detected by the second detecting means exceeds the allowable maximum value; and
informing means configured to inform of the determination results of the first and second determining means.

13. An apparatus of claim 9, wherein
the first detecting means samples the detected electric potential of the electric potential sensor at a specified time, after the charging unit is turned off by the first control means, and detects the dark attenuation characteristic of electric potential on the surface of the photo conductor according to the sampling result.

14. An apparatus of claim 9, further comprising:
third detecting means configured to detect the charged electric potential at the position corresponding to the electric potential sensor on the surface of the photo conductor, at the moment when the charged electric potential at the positions corresponding to the plural developing units on the surface of the photo conductor is maintained at the second set value, from the dark attenuation characteristic detected by the first detecting means; and
third control means configured to obtain the difference between the detected electric potential of the electric potential sensor and the charged electric potential detected by the fourth detecting means at the image formation where the plural developing units work, and compensates the value of the grid bias voltage set by the second control means by only the obtained difference.

15. An apparatus of claim 14, further comprising:
fourth control means configured to adjust the value of developing bias voltage that is impressed to the plural developing units, at the image formation where the plural developing units work, according to the value of the grid bias voltage compensated by the third control means.

16. An apparatus of claim 9, further comprising:
fifth control means structured so as not to give developing bias voltage to the plural developing units until the surface of the photo conductor charged by the charging unit corresponds to the plural developing units after the process by the first control means is started, and to give the developing bias voltage to the plural developing units when the surface of the photo conductor charged by the charging unit corresponds to the plural developing units, and decrease the value of the developing bias voltage as the detection electrical potential of the electric potential sensor goes down.

17. A method of controlling an image forming apparatus comprising: a rotating type photo conductor; a discharge unit configured to remove electric charge residual on the surface of the photo conductor; an charging unit configured to give electric charge to the surface of the photo conductor discharged by the discharge unit, and have a grid for adjusting charged output according to the value of impressed grid bias voltage; an exposure unit configured to expose the surface of the photo conductor charged by the charging unit; a developing unit configured to develop the surface of the photo conductor exposed by the exposure unit; and an electric potential sensor configured to detect charged electric potential on the surface of the photo conductor charged by the charging unit, the method comprising:
turning on the discharge unit and the charging unit and turning off the exposure unit, periodically or under predetermined conditions, and setting the value of the grid bias voltage at a predetermined value, and rotating the photo conductor, thereafter stopping the rotation of the photo conductor and turning off the discharge unit and the charging unit;
detecting dark attenuation characteristic of electric potential on the surface of the photo conductor according to detection results of the electric potential sensor, after the charging unit is turned off;
detecting a target value of the grid bias voltage necessary for maintaining charged electric potential of the position corresponding to the developing unit on the surface of the photo conductor at a predetermined set value, from the detected dark attenuation characteristic; and
setting the value of the grid bias voltage to the detected target value, at image formation where the developing unit works.
